(19) United States
(12) Patent Application Publication
(10) Pub. No.: US 2012/0290392 A1
(43) Pub. Date: Nov. 15, 2012

(54) Contextual Keywords Based Advertising System

(76) Inventor: Avanti Joshi, Pune (IN)

(21) Appl. No.: 13/556,233

(22) Filed: Jul. 24, 2012

Related U.S. Application Data
(63) Continuation-in-part of application No. PCT/IN2010/000753, filed on Nov. 19, 2010.

(30) Foreign Application Priority Data
Jan. 25, 2010 (IN) 197/MUM/2010

(51) Int. Cl. G06Q 30/02

(52) U.S. Cl. 705/14.53

(57) ABSTRACT

There is envisaged a method of contextual keywords based advertising on network enabled device comprising the steps of extracting the text and other contents in response to user action of entering the contents on network enabled device or in response to receiving any content and in response to data pushed or transferred from to output peripherals; identifying and extracting alpha numeric characters from the extracted contents; storing alpha numeric characters in a memory of the user device; forming meaningful keywords out of alpha numeric characters; randomizing the keywords; sending said keywords to the server over network; pulling advertisements in the form of marketing promotions/search results/information/content/applications/contents from advertisement server based on said keywords and storing retrieved advertisements in memory of device; receiving attributes for advertisements to be displayed and displaying the advertisements according to said attributes on the main or separate screen of network enabled device.

### CROSS-REFERENCE TO RELATED APPLICATIONS

This application is a continuation-in-part of PCT Patent Application Serial Number PCT/IN2010/000753, filed on Nov. 19, 2010, which claims priority from Indian Patent Application Serial Number 197/MUM/2010, filed on Jan. 25, 2010, both of which are hereby incorporated by reference herein.

### FIELD OF DISCLOSURE

The present disclosure relates to the field of recognizing contextual keyword(s) across application(s) and content(s) executed on network enabled devices and generating digital advertisements based on the contextual keywords. More particularly, the present disclosure relates to a system for extracting contextual keywords(s) directly from network enabled devices, without interfacing with the application(s) and content(s) executed on network enabled device(s). Still more particularly, the present disclosure relates to a system and related method(s) for displaying digital advertisements derived based on the contextual keyword(s), on network enabled device(s).

### BACKGROUND

Traditionally, commercial advertisements have been in the form of television commercials, radio commercials, and printed advertisements in magazines, newspapers. Most recently, as people began spending more and more time using personal computers, advertising has expanded to the internet. Conventional methods of contextual advertising involve capturing information over telecom carrier networks and servers, internet, search engine websites and in the form of cookies from web pages executed on internet browsers.

Conventional methods of advertising do not take into consideration the user context which can be determined based on data accessed by the user which may not be sent to telecom network or internet but consumed within the device via applications on device. Some of the conventional contextual advertising systems cannot be executed based on keywords context across applications and contents executed on device apart from internet browsers. Moreover, the implementation of conventional contextual advertisement systems depends upon the availability of the telecom carrier/telecom service provider network without which and the conventional contextual advertisement systems cannot function.

Further, as network enabled devices become increasingly popular; delivering advertisements to users of such devices is likely to become increasingly popular. Such devices include, for example, mobile telephones, portable media players, small form factor PCs or any other network enabled device with display, touch screen, motion/IR/gesture, keyboard and audio function etc. many of these devices include features such as cameras, text messaging capability, electronic mail capability, video playback capability, audio playback capability, image display capability, wired or wireless connections, storage, etc. Accordingly such devices are capable of displaying audiovisual/or text advertisements.

Mobile or wireless electronic advertising, in which advertisers connect with consumers through their cellular telephones, personal digital assistants [PDA] and other mobile devices, different form factor PCs, has exploded in recent years. For example, an advertiser may encourage cellular telephone uses to participate in trivia contests on internet, thereby opting into a marketing campaign which enables the advertisers to send those users coupons or promotional offers. Though this kind of advertising has exploded in recent years, use of mobile or wireless advertising and its many advantages has not been fully exploited. Accordingly many more innovative and effective uses mode of advertising may yet be possible.

### OBJECTS

In view of the foregoing background, it is therefore an object of the present disclosure to provide a system, apparatus, and associated method/s for contextual keyword(s) recognition across applications and contents based digital advertising with the help of data extraction on the device itself without interfacing with these software applications and contents via any software interface; even if these keywords or data is not sent to telecom network or internet server; optionally extended to marketing promotions, information, content, applications, search results discovery on these keywords as indirect advertisement of the same.

It is an object of the present disclosure to overcome or at least mitigate certain of the limitations of the above systems and methods.

### SUMMARY

According to the first aspect of the disclosure there is provided a method of advertising based on text, contents, data, alpha-numeric keywords from input and/or output peripherals, applications, middleware, central data rendering and capture software functions in applications or OS, kernel and/or device drivers involved for receiving or pushing the data from/to input output peripherals, on network enabled devices with display, mouse, touch screen, motion, IR, gesture sensors, storage, wired or wireless ports, sensors, camera, keyboard and audio input and/or output function. In accordance with the present disclosure, the extraction of text and contents from the network enabled device of the user and the subsequent display of advertisements on the network enabled device is an independent process which does not necessitate the transmission of extracted text and contents to the server associated with the telecom carrier, as is the case with conventional advertising systems. The advertisement, in accordance with the present disclosure can be in the form of marketing promotions, digital campaigns, information and content discovery, application discovery, search results including registered websites and related information.

According to the second aspect of the present disclosure, there is provided a method of digital advertising on user's device, the method comprising extracting the text, keywords, contents or actions from the data received by input peripherals like keyboard, touch screen, motion sensor, camera sensor, IR sensor, mouse, audio recorded, wired or wireless ports and the data pushed to output peripherals like display screen or audio output, or wired/wireless ports, or from file storage or transfer of content on device on input output peripherals, wherein the extraction can happen in operating system kernel layer or device driver layer or applications or central functions at OS or application layer responsible for capture of input data or render of output data to input peripherals and output peripherals respectively, identifying and extracting alpha numeric characters and keywords from the extracted contents, storing said characters in volatile and non volatile memory of user device, forming meaningful character of words out of said characters and randomizing it, pulling the advertisement contents from the server based on said alpha numeric characters and/or keywords and optionally storing the pulled advertisements in memory on the user device, receiving attributes for advertisements to be displayed on user device and displaying the said advertisement according to the said attributes, on the main and/or separate screen of network enabled user device at a particular location and in a particular form.

According to the third aspect of the disclosure there is provided a system for a digital advertising, the system comprising a network operable to support user device/s. The user device comprising an advertising module adapted to extract the contents, text, keywords, identify alpha numeric characters from the extracted contents and optionally storing said characters in the device memory. Further said module is adapted to form meaningful character of words from the characters stored in the memory of the user device and then randomizing them in any sequence.

According to fourth aspect of the disclosure the system further comprising a server operable to communicate in the network of user device/s, an advertising module for matching and pulling the advertisement contents from the server based on said alpha meaningful character of words, sending the pulled advertisements to the user device along with attributes for advertisements to be displayed on user device from the server and displaying said advertisement according to the said attributes, on the main or separate screen of network enabled user device. In accordance with the present disclosure, the retrieved advertisement can be selected from the group consisting of marketing promotions, digital campaigns, information and content discovery, application discovery, search results including registered websites and related information.

According to fifth aspect of the disclosure, a separate display screen is provided on the user device to display the advertisement as a part of multitasking application without disturbing the main screen and the operation on the main screen. There is also provided on the user device, a small navigation panel/keypad to scroll and enter the advertisement content displayed on the said separate screen. Further a split display can be provided on the main screen of the user device.

As mentioned in the second aspect of the disclosure the user device is network enabled device. Said network enabled device is one or more of mobile phone, PDA [Personal Digital Assistant, Smart phone, Feature Phone, Smart book, Tablet PC [Personal Computer], PC[Personal Computer], Notebook, Laptop or Net book or digital picture frame, or portable media player, or music player, or video player, or digital TV, or IPTV, or analog TV, or set top box, or kitchen appliance or a digital clock, or car infotainment device, or navigation device, or remote control of an electronic appliance or TV, or any other device which has one or more display screens and one or more audio speaker or headphone connector port, one or more keys or keypads, multifunction peripherals and Input output ports, and with one more application specific processors/chipsets. The network mentioned herein above comprises an internet or intranet or private or public close group peer to peer or broadcast network or wireless network.

The step of extraction of contents further comprises extracting the contents of frame or window buffer associated with one or more display screens, the key pressed out of different alpha numeric keys from the key/keypad content buffer, or can be an extraction of the contents at a location on the screen pressed by single/multiple/finger/resistor/capacitive/stylus based touch screen or mouse clicks buffer, or can be an extraction of the contents at a location on the screen located by motion/gesture/IR sensor buffer, or from content and/or file storage or content and/or file transfer from/to volatile or nonvolatile internal and external memory of the network enabled device or memory drives connected to the network enabled device, or the contents from speech to text conversion of received audio from microphone or audio in port, in volatile or nonvolatile memory, or any type of contents used in transfer from wired or wireless or satellite or radio communication ports. The extraction of text and contents, in accordance with the present disclosure can also take place at the operating system kernel level. Alternatively the text and contents can be extracted from the device driver layer of the network enabled device. Alternatively, applications or central functions responsible for capturing of input data from input peripherals and rendering of output data to output peripherals can also be utilized for the purpose of extracting relevant text and contents. In accordance with the present disclosure, the text and contents can also be extracted from functions and arrays/buffers of applications, middleware, kernel or device driver's layers of operating system, which are responsible for rendering text, image, video, audio and also responsible for recording audio/video.

The alpha numeric characters extracted from the said content are digits, numbers, text, words, and strings and these characters are stored in another buffer in volatile or non volatile memory in random fashion rather than in the sequence of recording/extraction, to safeguard user privacy. The attributes received from the advertisement server for display of an advertisement on the screen of network enabled device is in the form of user profile, advertisement repetition count, time, form, position and size and other relevant information.

Further, the method of advertising material and playback on network enabled device can be of the form of text, audio, picture, video, 2D, 3D graphics, image, animation, moving picture, banner, web links, hyperlinks, file attachment, flash, SMS, mms, email and the like.

According to the third and fourth aspects of the present disclosure, means are provided that are adapted to extract the contents, identify alphanumeric characters from the extracted contents and store said characters in the memory module of the network enabled device, for forming meaningful keywords from the characters stored in the memory module of the network enabled device, randomizing the meaningful keywords, and match and retrieve the advertisements based on the meaningful keywords from the remote server onto the networked enabled device and then handover to advertisement display application for display or playback of relevant advertisement pulled from server over network and/or stored on the network enabled device based on those contents.

According to the fifth object of the present disclosure a separate display screen is provided other than the main screen, the location of which can be on top, below of alphanumeric keypad, touch screen, and keywords main screen in a candy bar or clamshell or slider type device for viewing the pulled advertisements and an application to display advertisements and also any other text of SMS, email, message, video, image as part of multitasking applications in these screens.

The display screen of the network enabled device according to the present disclosure is selected from the group consisting of LCD (Liquid Crystal Display), LED (Light Emitting Diode Display), EInk (Electronic Ink Display), OLED (Organic Light Emitting DiodeDisplay), PLED (Polymer Light Emitting Diode Display), AMOLED (active matrix organic light emitting diode display), FED (Field Emission Display), IMOD (inter ferometric modulator display), Plasma.

The system and method envisaged by the present disclosure also contemplates giving an option to the user to select his choice of category of advertisements like sports, health entertainment, politics, consumer durables, general knowledge, books, white goods, consumer goods, groceries, fashion, apparels, electronics, etc. to be pulled, and display only the relevant selected categories on the screen. Further the techniques of the present disclosure can be used in 2D/3D/Animated/Video virtual malls over internet, virtual shops of each brand owner, and advertisement in each virtual mall or shop of a particular brand.

The preceding is a simplified summary of the contextual keywords based advertising system, which aims to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above.

### BRIEF DESCRIPTION OF THE DRAWINGS

The Contextual Keywords Based Advertising System is described in accordance with the appended figures.

FIG. 1: shows an illustrative representation of a network enabled network enabled device along with the display screen that may be used for displaying an advertisement.

FIG. 2: shows a block diagram of the relevant portions of the network enabled device of FIG. 1 in accordance of the present disclosure FIG. 3: shows a block diagram of a system according to the present disclosure, in which a network enabled device of FIG. 1, may operate.

FIG. 4 and FIG. 5: show a flow chart of a process of displaying advertisements on a network enabled device.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION OF THE ACCOMPANYING DRAWINGS

As used throughout this patent document, the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this document. Those of ordinary skill in the art should understand that in many, if not most instances, such definitions apply to prior as well as future uses of such defined words and phrases.

For purposes of illustration, the invention will be described primarily in the context of displaying advertisements on a network enabled device that may include mobile device/mobile telephone. However it will be appreciated that the invention is not intended to be limited to the context of a mobile device/mobile telephone and may relate to any type of an appropriate electronic device, examples of which include Feature Phone, or Smart book, or Tablet PC or PC or Notebook or Laptop or Net book or digital picture frame, or portable media player, or music player, or video player, digital TV, IP TV, analog TV, set top box, kitchen appliance a digital clock, car infotainment device, VOIP phones, IP phones, remote control of a TV or any electronic appliance and a navigation device.

As will be recognized, the contextual keywords based advertising system may also be adapted to display advertisements on a network enabled device via 2D/3D/Animated video, virtual malls over internet, virtual shops of each brand owner, and advertisement in each virtual mall or shop of a particular brand. In this method of advertising, user can log in using his/her username and password in every virtual mall or a virtual shop and select a product line using mouse click or key button pressed on keyboard attached to the network enabled device having access to these virtual malls over internet. The time spent in watching/listening and number of clicks and number of shops visited and number of products and advertisement watched by the user in the virtual malls and shops over internet from the network enabled device is recorded, stored on the network enabled device, and pushed to a server. The user gets paid or given a share of revenue in terms of money or in terms of rewards, gifts, discount coupons, offers, vouchers, etc for the time spent in watching/listening or number of advertisement clicked or number of shops visited, in these virtual malls and shops over internet.

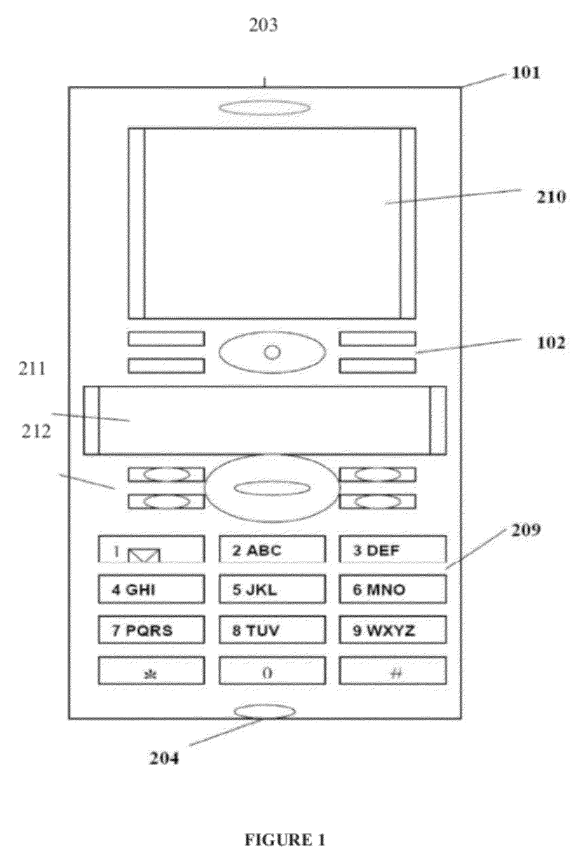

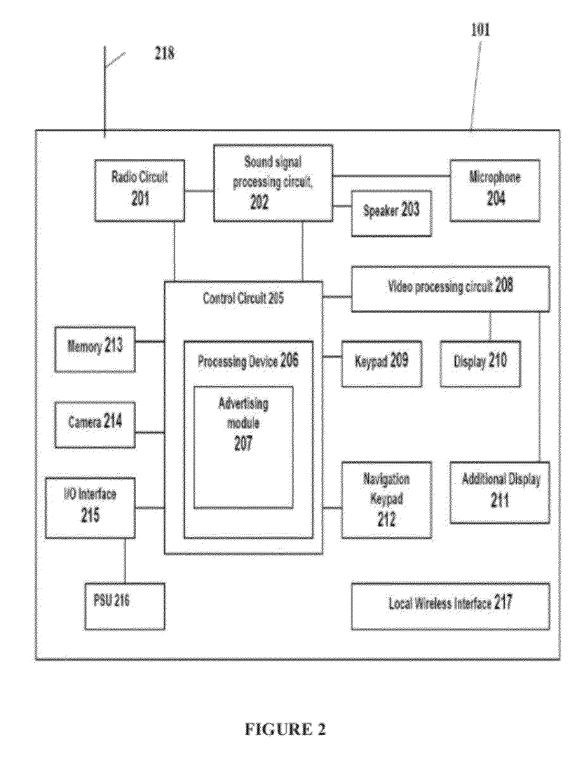

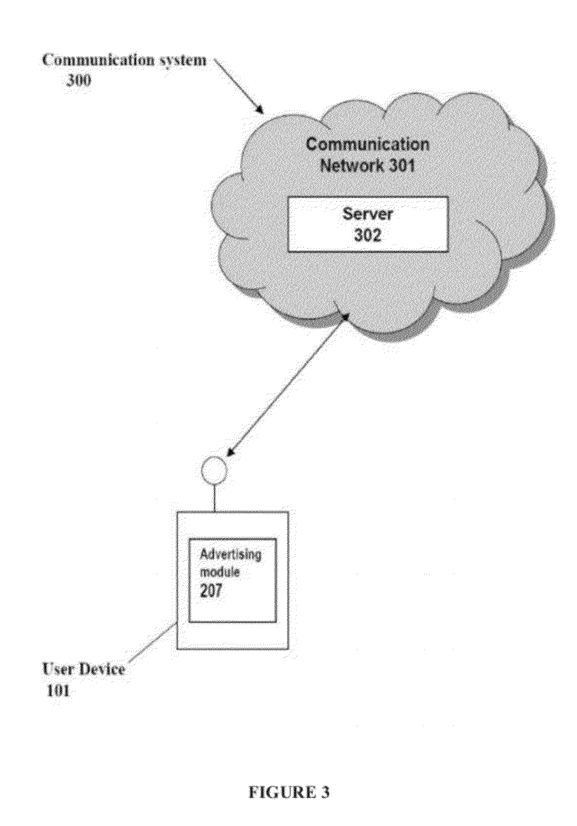

Now referring to FIG. 1 and FIG. 2 a mobile device 101 is shown. A mobile device 101 includes an advertising module 207. More details and an operation of advertising module 207 will be described in detail below. An advertising module may be incarnated in the form of executable code that is stored in and executed by the mobile device 101. An advertising module may form a best and alone software application or form a part of the software that carries out additional tasks related to mobile device 101 and said advertising module in the form of software program, stored in computer or computer readable medium.

The mobile device 101 includes a display 210. The display 210 displays information to a user such as telephone number, contact information, and various navigational menus, contents received by mobile device 101 and retrieved from a memory 213 [FIG. 2] of the mobile device 101. The mobile device may have one or more display screens 211 to display the information mentioned above along with an additional navigational key pad 212.

A keypad 209 provides for a variety of user input operations. For example key pad 212 typically includes alphanumeric keys for allowing entry of alphanumeric information such as telephone numbers, contact information, notes etc. Special function keys 102 may include menu navigation and to facilitate navigating through a menu displayed on the main display or additional display screen 211 for navigating through a menu displayed on additional display screen 211 of the mobile device 101.

The mobile device 101 includes call circuitry that enables mobile device 101 to establish a call or exchange signals with called/calling device like mobile device, internet web server, content providing server such as advertisement server and call can be of any form such as voice over Internet Protocol [VOIP], video enabled call, call over GSM, GPRS, CDMA, and 3G call over an alternative packet switched network such as WiFi, WiMAx etc.

The mobile device 101 may be configured and adapted to transmit, receive, process data such as text messages, email messages, instant messages, multimedia messages, image files and so forth. Processing such data may include storing the data in a memory 213 executing applications to allow user interaction with the data and so forth.

Now referring to FIG. 2 which is a functional block diagram of mobile device/mobile telephone 101. The mobile device 101 includes a control circuit 205 that is configured to carry out overall control of the functions and operations of the mobile device 101. The control circuit 205 may include processing device 206 such as CPU [Central Processing Unit], microcontroller and so forth. The processing device executes code stored in a memory within the control circuit 205 or in a separate memory 213 in order to carry out the operation of the mobile device. The memory may be one or more of a buffer, flash drive, hard drive, volatile and non-volatile memory and so forth.

The processing device 206 executes and implements the advertising module 207. Details as to specific programming code have been left out for the sake of brevity. Further, said functionality of advertising module could also be carried out by separate and dedicated hardware, software, or combinations thereof without departing the scope of the disclosure.

The mobile device 101 further includes an antenna 218 coupled to a radio circuit 201. The radio circuit 201 includes conventional transmitters and receivers. The radio circuit 201 may be configured to operate mobile communication system and may be used to send and receive data and audiovisual content. Receiver types for interaction with a mobile radio network and broadcasting network include but are not limited to GSM, CDMA, WCDMA, GPRS, 3G, WiFi, Wi MAX, and so forth as well as advanced version of these standards.

The display 210 or an additional display 211 may be coupled to the control circuit 205 by a video processing circuit 208 that converts video data to a video signal used to drive the display 210 or an additional display 211. There are other device parts present in the mobile device 101 such as one or more interface 215 and power supply unit (PSU) 216, camera 214, and local wireless interface 217 such as Bluetooth interface for establishing connection with an accessory or to another mobile phones.

Now referring to FIG. 3 the mobile device 101 is configured to operate as a part of communication system 300. The system includes a communications network 300 having a server 302 or servers for carrying out various support functions along with management of calls. The server 302 communicates with the mobile device 101 via transmission channel. The transmission channel is any appropriate device or assembly including but not limited to a cell tower, another mobile device, a satellite etc. As may be appreciated the server 302 may be configured to store and execute advertising functionalities that interact with the advertising module 207 of the mobile device 101. Details of the interaction between advertising server 302 and the advertising module of the mobile device 101 will be described below in details.

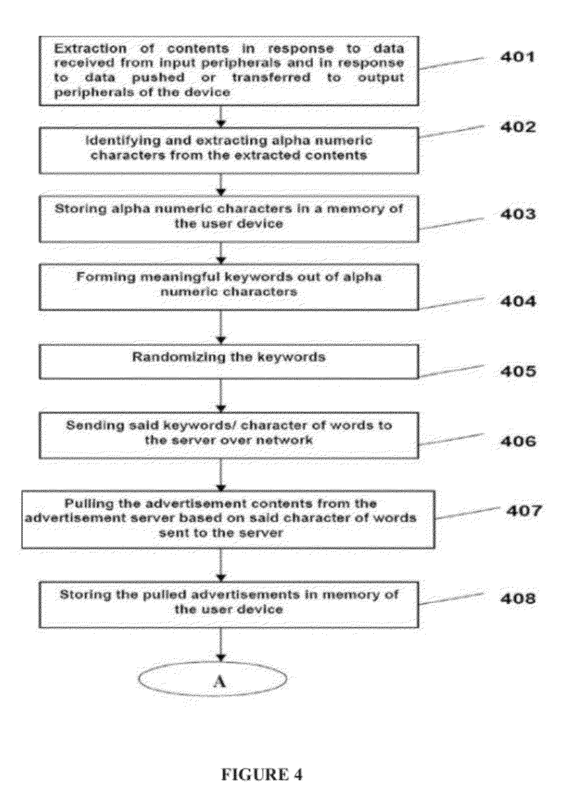

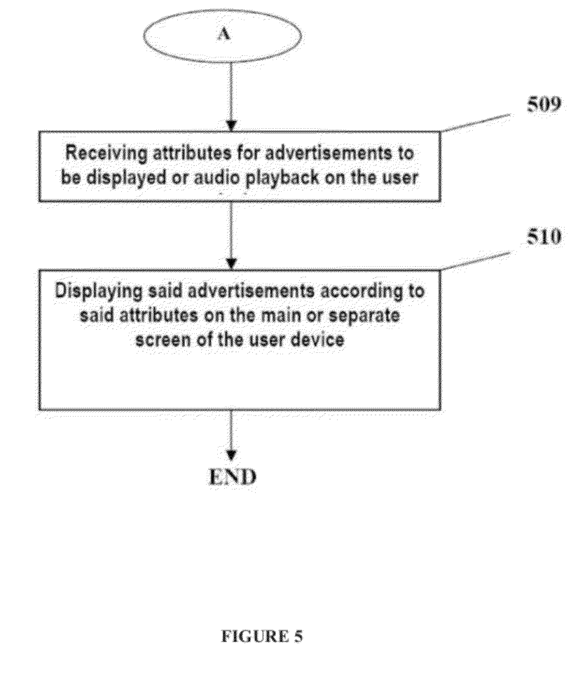

Now referring to FIG. 4 and FIG. 5 which illustrate the exemplary method of displaying advertisement on the network enabled device. The exemplary methods may be thought of depicting steps of a method carried out by the network enabled device.

At step 401, in response to the user action of entering the contents on network enabled device, contents are extracted from the data received by input peripherals-and/or the data pushed to output peripherals of the network enabled device. Further the contents are also extracted from one of frame or windows buffers associated with one or more display screens, the key pressed out of different alpha numeric keys from the key/keypad content buffer, from a location on the screen pressed by single, multiple, finger, resistor, capacitive, stylus based touch screen, from allocation on the screen located by motion or gesture or IR sensors buffer, Bluetooth, WiFi, LAN, etc. or from file storage or file transfer from and to the memory of the device or memory drives connected to the device, and the contents from speech to text conversion of received audio from microphone or audio in port, in a memory. Further, in addition to the content extraction from input and output peripherals, contents are also extracted from the data stored on volatile and non-volatile storage of the network enabled device.

As mentioned in step 401 the input peripherals may include keyboard, touch screen, motion sensor, camera sensor, IR sensors track pad, scroll wheel, audio recorder or input microphone or any other audio input port, software or hardware based speech and audio to text converter, volatile or non volatile memory, Bluetooth, WiFi, LAN (Local area network), USE (universal serial bus), UART (universal asynchronous receiver transmitter, RS232, JTAG (Joint test action group), any serial or parallel port, electronic and regular smart pen used to record data when used for writing on paper or other material and the output peripherals may include display screen or audio output, or from file storage or transfer or hdmi port, or spdif port, or volatile and non volatile memory, headphone or ear piece, Bluetooth, WiFi, LAN, USB, UART, RS232, JTAG or any serial or parallel ports.

The network enabled device as mentioned herein is network enabled device and said network may include an internet or intranet or private or public close group peer to peer or broadcast network or wireless, and analog or digital network. Further said network enabled device may include one or more of mobile phone1 mobile device, PDA [Personal Digital Assistant], Smart phone, Feature Phone, Smart book, Tablet PC [Personal Computer], PC [Personal Computer], Notebook, Laptop, Net book, digital picture frame, portable media player, music player, video player, digital TV, IP TV, analog TV, set top box, kitchen appliance a digital clock, car infotainment device, VOIP phones, IP phones, remote control of a TV or any electronic appliance and a navigation device.

At step 402 alpha numeric characters are identified and extracted from the contents extracted at step 401. An identified alpha numeric characters and includes but not limited digits, numbers, text, words, and strings. The alphanumeric characters identified at step 402 are the stored in the memory module of network enabled device at step 403. The identified characters are stored in the memory module of network enabled device 101 in random fashion rather than in the sequence of recording and extraction. After storing the alphanumeric characters, meaningful keywords words are formed at step 404. After forming the meaningful character keywords words, said keywords words are randomized at step 405. After randomizing the keywords, said keywords words are being sent to the server 302 at step 406 over the network 301. The network 301 comprises an internet or intranet or private or public close group peer to peer or broadcast network or wireless, and analog or digital network. At step 407 the advertisement contents are being pulled from the advertisement server 302 based on said character of words sent to the server 302 and storing the pulled advertisements in the memory 213 of the network enabled device 101.

FIG. 5 depicts the further steps of process steps depicted in FIG. 4. Once the pulled advertisements stored on the network enabled device at step 407, at step 501 attributes for advertisements are bring received from the advertisement server 302 and the advertisements that are stored in the memory module 213 of network enabled device 101 are being displayed according to said attributes on the separate screen of the network enabled device 101 at step 510. Said attributes received from the advertisement server 302 for display of an advertisement on the screen of network enabled device 101 are in the form of time, form, position, and size. An advertisement is notified to the user via an audio announcement. The form of displaying advertising at step 510 may include one of text, audio, picture, video, 2D, 3D graphics, image, animation, moving picture, banner, web links, and hyperlinks, file attachment, flash, SMS, mms, email.

The separate screen as mentioned is a split display provided on the main screen of the network enabled device or a secondary display screen on the device in addition to main screen to see SMS [Short Message Service], email, message, social networking message posts, advertisements, news, or any other digital content on this second screen, on their arrival to the device from network or after stored on the device, without mixing or changing the content of main screen. Said display screen on the network enabled device is located on top or below of alphanumeric keypad, and the main screen and said separate screen may include one of the shape of a candy bar, clamshell and slider type device. The display screen of the network enabled device 101 may include LCD (Liquid Crystal Display), LED (Light Emitting Diode Display), EInk (Electronic Ink Display), OLED (Organic Light Emitting DiodeDisplay), PLED (Polymer Light Emitting Diode Display), AMOLED (active matrix organic light emitting diode display), FED (Field Emission Display), IMOD (interferometric modulator display), Plasma.

Another embodiment contemplates a technique of revenue share using the present disclosure wherein whenever a user clicks on advertisement, or allows advertisement to be posted, or watches the advertisement for a particular duration, or spend time in watching and listening to advertisements, or reply or get engaged in the advertisement on a interactive basis, or fill up market survey and market feedback forms, or any other from of brand owners, on device which has some form of display screen and is network enabled, then the user gets paid on a revenue share model between publisher, advertisement content brand owner and end user. The payment can be of the form of depositing money in the user bank account, or gifts, or rewards, or discounts, or vouchers or cards which can be exercised with different brand owners.

The foregoing description of an advertisement system and methods thereof has been presented for the purposes of illustration and description. It is not intended to be exhaustive or to limit the claimed subject matter to the precise form disclosed. Many modifications and variations are possible in light of the above teaching. It is intended that the scope of the disclosure be limited not by this detailed description, but rather by the claims appended hereto.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1) A method for contextual keyword(s) based advertising on a network enabled device, said method comprising, in no particular order, the steps of:
extracting at least text and contents in response to user action of entering/transferring the contents on to a network enabled device, data transfer from input peripherals and in response to the data pushed/transferred to output peripherals of said network enabled device;
extracting text, keywords, contents in operating system kernel layer or device driver layer or applications or central functions at OS or application layer responsible for capture of input data or render of output data to input peripherals and output peripherals respectively;
identifying and extracting alpha numeric characters and keywords from the extracted text and contents;
storing said alpha numeric characters and keywords in a memory module of the network enabled device;
forming meaningful keywords from said alpha numeric characters;
randomizing said meaningful keywords;
transmitting said meaningful keywords, along with application name/content name/url from where said keywords are extracted to a remote advertisement server;
retrieving at least one of advertisements, marketing promotions, information and content, applications, search results including registered websites and related information from the advertisement server based on said meaningful keywords and storing the retrieved advertisements in the memory module of said network enabled device;
receiving attributes corresponding to content retrieved from said advertisement server and displaying said content according to said attributes on the main screen or separate screen of said network enabled device.

2) The method as claimed in claim 1, wherein the step of extracting at least text and contents further includes the step of extracting the text and contents from frame or window buffers associated with one of one or more display screens, frame buffers associated with audio recording or playback, the key pressed out of different alpha numeric keys, from keypad content buffer, from a location on the screen pressed by single, multiple, finger, resistor, capacitive, stylus based touch screen, from a location on the screen located by motion or gesture or IR sensors buffer, from file storage or file transfer from and to the memory module of the network enabled device, from memory drives connected to the network enabled device, wired or wireless ports and from the contents corresponding to speech to text conversion of audio received from a microphone or audio port.

3) The method as claimed in claim 1, wherein the method further includes the step of extracting the text and contents from the data stored on volatile and nonvolatile Storage of said network enabled device.

4) The method as claimed in claim 1, wherein said input peripherals include input peripherals selected from the group consisting of keyboard, touch screen, motion sensor, camera sensor, IR sensors, track pad, scroll wheel, audio recorder or input microphone or any other audio input port, software or hardware based speech/audio to text converter, volatile or non volatile memory, Bluetooth, WiFi, LAN, IJSB, UART, RS232, JTAG (Joint Test Action Group)/any serial or parallel port, an electronic and regular smart pen used to record digital data when used for writing on paper or other material.

5) A method as claimed in claim 1, wherein said output peripherals are selected from the group of output peripherals consisting of display screen, audio output from file storage, hdmi port, spdif port, volatile and nonvolatile memory, headphone or ear piece, Bluetooth, WiFi, LAN, USE, UART, RS232, JTAG, any serial or parallel ports.

6) The method as claim in claim 1, wherein said network includes an internet or intranet, private or public close group peer to peer or broadcast network, wireless, and analog or digital network.

7) The method as claimed in claim 1, wherein said network enabled device is selected from the group of network enabled devices consisting of mobile phone, PDA [Personal Digital Assistant], Smart phone, Feature Phone, Smart book, Tablet PC [Personal Computer], PC [Personal Computer], Notebook or Laptop, Net book, digital picture frame, Ebook reader, portable media player, music player, video player, digital TV, IP TV, analog TV, set top box, kitchen appliance a digital clock, car infotainment device, VOIP phones, IP phones, remote control of a TV and a navigation device.

8) The method as claimed in claim 1, wherein said alpha numeric characters include digits, numbers, text, words, and strings.

9) The method as claimed in claim 8, wherein said alpha numeric characters are stored in the memory module of said network enabled device in random fashion rather than in the sequence of recording and extraction.

10) The method as claimed in claim 1, wherein said attributes received from the advertisement server for display of an advertisement on the screen of user device are in the form of at least time, form, position, and size.

11) The method as claimed in claim 1, wherein the step of displaying advertisements further includes the step of displaying advertisements in the form selected from the group of forms consisting of text, audio, picture, video, 2D, 3D graphics, image, animation, motion picture, banner, web links, hyperlinks, file attachment, flash, SMS, mms, email.

12) The method as claimed in claim 1, wherein said separate display screen is a split display provided on the main screen of the network enabled device or a secondary display screen on the device in addition to main screen to facilitate viewing of SMS, email, message, social networking message posts, advertisements, news, or any other digital content on this second screen, on their arrival to the network enabled device from network or from memory module of the network enabled device, without mixing or changing the content on the main screen.

13) The method as claimed in claim 12 wherein said separate screen on the user device is located at a location selected from the group of locations consisting of top of alphanumeric keypad below the alphanumeric keypad, and on the main screen.

14) The method as claimed in claim 13 wherein the shape of the separate screen is selected from a group of shapes consisting of shape of a candy bar, clamshell and slider.

15) The method as claimed in claim 14 wherein said display screen is selected from the group of display screens consisting of LCD (Liquid Crystal Display), LED (Light Emitting Diode Display), EInk (Electronic Ink Display), OLED (Organic Light Emitting Diode Display), PLED (Polymer Light Emitting Diode Display), AMOLED (active matrix organic light emitting diode display), FED (Field Emission Display), IMOD (interferometric modulator display) and Plasma screen.

16) The method as claimed in claim 1 wherein availability of an advertisement on the network enabled device is notified to the user via an audio announcement.

17) A system for displaying contextual keyword(s) based advertisements on a network enabled device, said system comprising: a network to establish a communication link to a communication network enabled advertisement server and an advertising module located on the network enabled device; wherein said advertising module is adapted to extract at least text and contents in response to the user action of entering the contents from input peripherals and data pushed to output peripherals of network enabled device, identify alphanumeric characters from the extracted text, contents and store said alpha numeric characters in the memory module of said network enabled device, for forming meaningful keywords from said alpha numeric characters, randomize said meaningful keywords and transmit said randomized, meaningful keywords to the advertisement server; retrieve at least advertisements from the remote advertisement server based on said meaningful keywords and storing retrieved advertisements in the memory module of said network enabled device; receive attributes for advertisements to be displayed on the network enabled device wherein said advertisement is displayed, on the main or separate screen of the network enabled device.

18) A system as claimed in claim 17 wherein user device comprises one or more of mobile phone or PDA, or Smart phone, or Feature Phone, or Smart book or Tablet PC or PC or Notebook or Laptop or Net book or digital picture frame, or portable media player, or music player, or video player, digital TV, IP TV, analog TV, set top box, kitchen appliance a digital clock, car infotainment device, and a navigation device.

19) A system as claimed in claim 17 wherein separate display screen is a split display provided on the main screen of the user device.

20) A system as claimed in claim 19 wherein said separate display screen on the user device is located on top or below of alphanumeric keypad, and main screen.

21) A system as claimed in claim 20 wherein said separate display screen comprises one of the shape of a candy bar, clamshell and slider type device.

22) A system as claimed in claim 17 wherein said display screen is selected from the group of display screens consisting of LCD (Liquid Crystal Display), LED (Light Emitting Diode Display), EInk (Electronic Ink Display), OLED (Organic Light Emitting Diode Display), PLED (Polymer Light Emitting Diode Display), AMOLED (active matrix organic light emitting diode display), FED (Field Emission Display), IMOD (interferometric modulator display), Plasma screen.

23) A system as claimed in claim 17, wherein said network enabled device comprises a separate navigation keypad for scrolling and entering advertisement content.

24) A system as claimed in claim 17 wherein said keypad is a navigation keypad provided with at least five buttons.

25) A system as claimed in claim 24 wherein said buttons are provided with left, right, up, down, center scrolling functionality to read the contents displayed on the screen of the user device.

26) A system as claimed in claim 17, wherein said advertising module is further adapted to extract the text and contents from the data stored on volatile and nonvolatile storage of the network enabled device.

27) A system as claimed in claim 17 wherein availability of said advertisement is notified to the user via an audio announcement.
